(19) United States
(12) Patent Application Publication
(10) Pub. No.: US 2005/0211502 A1
(43) Pub. Date: Sep. 29, 2005

(54) Ladder assembly for vehicles and method of using the same

(76) Inventor: Richard LaBrash, Salem, MO (US)

Correspondence Address: Clyde L. Smith;Thompson Coburn LLP, One US Bank Plaza, St. Louis, MO, 63101-9928, US

(21) Appl. No.: 10/812,151

(22) Filed: Mar. 29, 2004

(51) Int. Cl. B62C 1/06; B60P 3/34; B62D 33/08; E06C 5/00; B63B 7/00

(52) U.S. Cl. 182/127

(57) ABSTRACT

A ladder assembly is specifically configured to be attached to an upright tailgate of a vehicle in a manner facilitating the ingress and egress of personnel into and out of such a vehicle while the tailgate remains in its upright position. The ladder assembly preferably comprises an attachment portion having a pair of clamps that allow the ladder assembly to be firmly attached to tailgates of differing thickness. The ladder assembly also preferably comprises a ladder portion that can be both folded and selectively inclined.

### BACKGROUND OF THE INVENTION

(1) Field of the Invention

This invention pertains to the field of vehicular ladder assemblies. More particularly, this invention pertains to a ladder assembly that is configured and adapted to be mounted to the upright tailgate of a vehicle and that is adjustable between stowed and operable configurations.

(2) Background

Military personnel-transport trucks and utility vehicles are often provided with tailgates. Typically, such tailgates are adjustable from their normal upright position for facilitating egress and ingress of personnel onto or into such vehicles. However, in some situations, it has become increasingly desirable to maintain such tailgates in an upright position, even though personnel must pass over such upright tailgates during ingress and egress. One such situation is when the compartment area of a truck or utility vehicle is lined with sandbags or other material so as to shield the personnel being transported therein from small-arm fire. In this situation, the upright tailgate often supports a wall of sandbags and therefore must remain in its upright position. In other situations, it may be desirable to enter and exit a vehicle over an upright tailgate simply to save the time that would otherwise be required to adjust the tailgate. Still other times, it may simply be that the tailgate is non-adjustable and therefore is always in an upright position.

Regardless of the reason for it being desirable to egress and ingress a vehicle by passing over the vehicle's upright tailgate, the tailgate nonetheless typically becomes an obstacle. As is especially the case with large military transport trucks, the height of the top of the tailgate when upright often makes it impractical, if not impossible, to simply jump or lift oneself over the tailgate when attempting to get into or onto the vehicle. Likewise, such height makes it more difficult to simply jump down from the vehicle without sustaining injury.

Although it is known to utilize ladders in connection with vehicles for various purposes, most often such ladders are permanently fixed to vehicles and are non-adjustable. As a result, such ladders are often not practical for use in traversing upright tailgates.

### SUMMARY OF THE INVENTION

The present invention facilitates the passage of personnel over the upright tailgates of vehicles and is simple and practical to use. In general, the invention pertains to a ladder assembly that is specifically configured to be attached to an upright tailgate and that has other beneficial features.

In one aspect of the invention, a ladder assembly comprises a ladder and an attachment portion. The ladder portion has a plurality of rungs and is pivotally connected to the attachment portion. The attachment portion has a clamping device that is configured and adapted to releasably secure the attachment portion to an upright tailgate of a vehicle. Additionally, the ladder portion is selectively lockable in at least a first pivotal orientation relative to the attachment portion.

In another aspect of the invention, a method comprises a step of providing a vehicle that has an upright tailgate. This method also comprises a step of providing a ladder assembly. The ladder assembly comprises a ladder portion and an attachment portion. The ladder portion has first and second sections and each of the first and second sections comprises a plurality of rungs. The first section of the ladder portion is movably connected to the second section in a manner such that the ladder portion is adjustable between a collapsed configuration and an extended configuration. Additionally, the first section of the ladder portion is pivotally connected to the attachment portion and selectively lockable in at least a first pivotal orientation relative to the attachment portion. The method further comprises steps of attaching the attachment portion of the ladder assembly to the tailgate of the vehicle, and pivoting the ladder portion relative to the attachment portion in a manner moving the first section of the ladder portion to the first pivotal orientation relative to the attachment portion. Still further, the method comprises steps of locking the first section of the ladder portion in the first pivotal orientation relative to the attachment portion, and moving the second section of the ladder portion relative to the first section in a manner adjusting the ladder portion between the collapsed configuration and the extended configuration.

In yet another aspect of the invention, a method comprises a step of providing a vehicle that comprises an upright tailgate. The upright tailgate has a top surface and opposite front and back sides. The method also includes a step of providing a ladder assembly that comprises a ladder portion and an attachment portion. The ladder portion comprises a plurality of rungs and the attachment portion comprises an adjustable clamp. The ladder portion is connected to the attachment portion. The method further comprises attaching the attachment portion of the ladder assembly to the tailgate of the vehicle in a manner such that the attachment portion straddles the top surface of the tailgate. Additionally, the method comprises adjusting the clamp of the attachment portion in a manner such that the clamp applies a clamping force against the front and back sides of the tailgate.

Still further, in another aspect of the invention, a ladder assembly comprises a ladder portion and an attachment portion. The ladder portion has first and second sections, each of which comprises a plurality of rungs. The first section of the ladder portion is movably connected to the second section of the ladder portion in a manner such that the ladder portion is adjustable between a collapsed configuration and an extended configuration. Additionally, the first section of the ladder portion is pivotally connected to the attachment portion and is selectively lockable in at least a first pivotal orientation relative to the attachment portion. Moreover, the attachment portion of the ladder assembly is configured and adapted to attach to an upright tailgate of the vehicle.

While the principal advantages and features of the invention have been described above, a more complete and thorough understanding of the invention may be obtained by referring to the drawings and the detailed description of the preferred embodiment, which follow.

### BRIEF DESCRIPTION OF THE DRAWINGS

FIG. 1 is perspective view of a preferred embodiment of a ladder assembly in accordance with the invention.

FIG. 2 is a side view of the ladder assembly shown in FIG. 1 and is shown with the ladder portion in an operable configuration and the attachment portion shown attached to an upright tailgate.

FIG. 3 is a side view similar to FIG. 2, but is shown with the ladder portion in a stowed configuration.

FIG. 4 is a top view of the locking mechanism of the ladder assembly of FIG. 1, along with other select portions of the ladder assembly, and is shown with the locking members in the locking position.

FIG. 5 is a top view similar to FIG. 4 with the locking members shown in the unlocking position.

Reference characters in the written specification indicate corresponding items shown throughout the drawing figures.

### DETAILED DESCRIPTION OF THE PREFERRED EMBODIMENT OF THE INVENTION

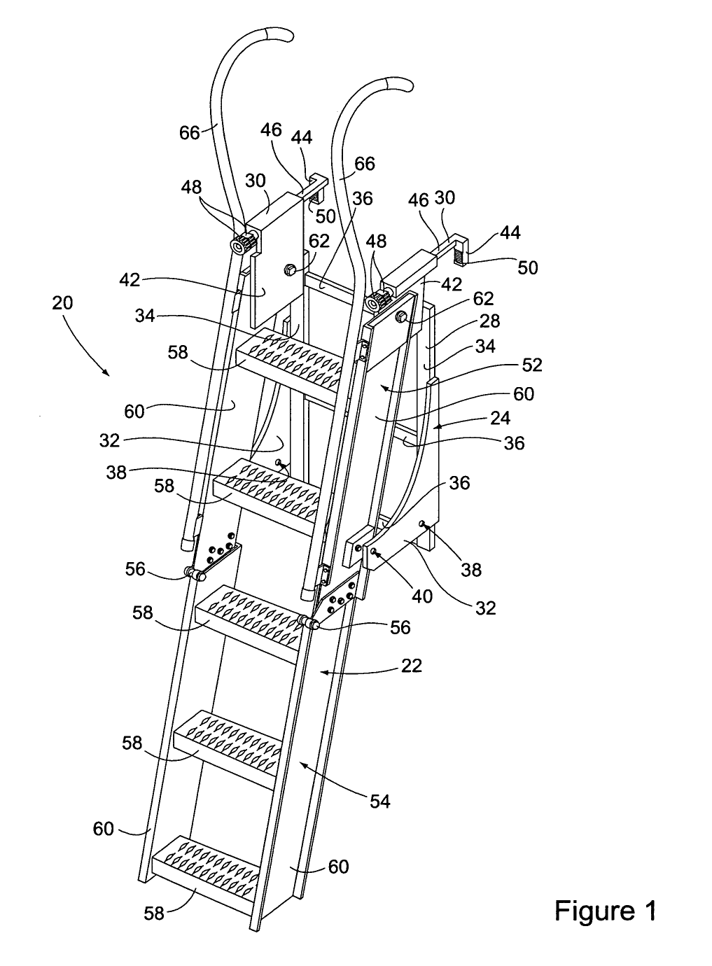

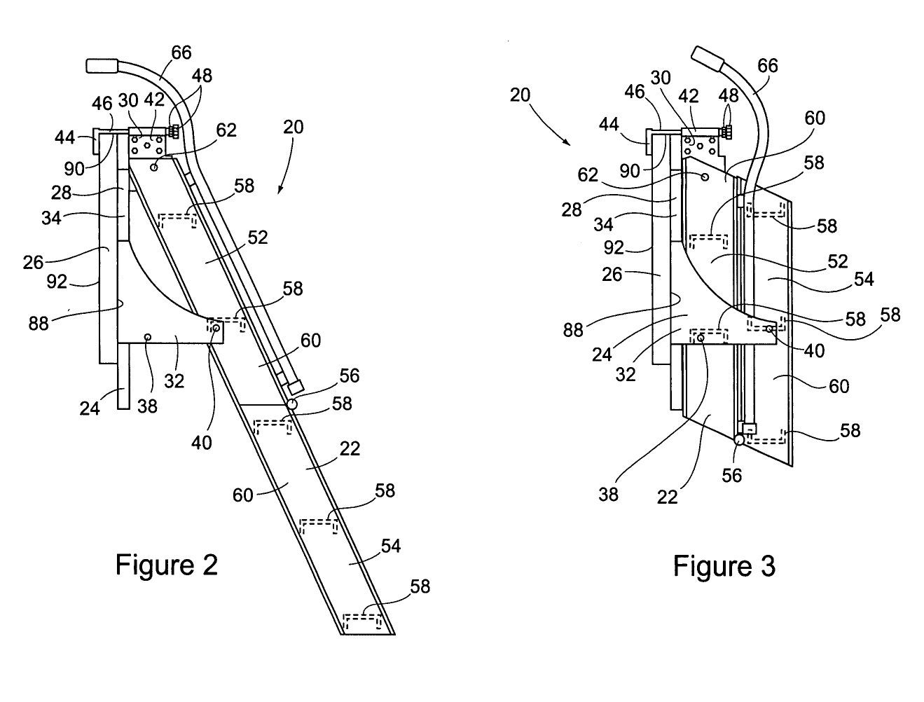

The preferred embodiment of a ladder assembly 20 in accordance with the invention is shown in FIG. 1 and generally comprises a ladder portion 22 and an attachment portion 24. The ladder assembly 20 is configured and adapted to be selectively secured to an upright tailgate 26 of a vehicle as shown in FIGS. 2 and 3. The ladder assembly 20 is preferably formed of metal, such as aluminum or steel, or other suitable strong and rigid materials.

The attachment portion 24 of the ladder assembly 20 preferably comprises a main body 28, a pair of clamps 30, and a pair of cantilevered ladder braces 32. The main body 28 of the attachment portion 24 is preferably a frame-like structure formed of welded extruded strip material. As shown, the main body 28 comprises a pair of spaced apart columns 34 connected by a plurality of spaced apart beams 36. The ladder braces 32 are preferably cantilevered from the columns 34 of the main body 28 and are preferably welded or otherwise rigidly fixed thereto. Each of the ladder braces 32 preferably comprises a first locking hole 38 that is axially aligned with the first locking hole of the other ladder brace. Additionally, each of the ladder braces 32 preferably comprises a second locking hole 40 that is axially aligned with the second locking hole of the other ladder brace.

Each of the clamps 30 preferably comprises a mounting member 42, a jaw member 44, a tensioning member 46, and a pair of locking nuts 48. The mounting member 42 is preferably welded or otherwise rigidly fixed to the main body 28 of the attachment portion 24 and preferably has a through-hole (not visable) for slidably supporting the tensioning member 46 in an orientation as shown in the figures. The through-hole preferably has a square cross-section. The jaw member 44 is preferably rigidly connected to one end of the tensioning member 46 and preferably comprises a plurality of gripping serrations 50 that face toward the tensioning member. The tensioning member 46 is preferably an elongate member having a square cross-section. A portion of the length of the tensioning member 46, from the end of the tensioning member opposite the jaw member 44, is preferably threaded. The locking nuts 48 are threadably engaged with the threaded portion of the tensioning member 46 and bear against the mounting member 42 of the clamp 30 to thereby allow the jaw member 44 to be adjustably forced and/or moved toward the mounting member by the tensioning member. The two locking nuts 48 of each clamp 30 are preferably configured and adapted to be rotated by hand and can be tightened against each other so as to lock themselves in place relative to the tensioning member 46. The square cross-sections of the tensioning member 46 and the through-hole of the mounting member 42 cooperate with each other to prevent the tensioning member from rotating as the locking nuts 48 are adjusted.

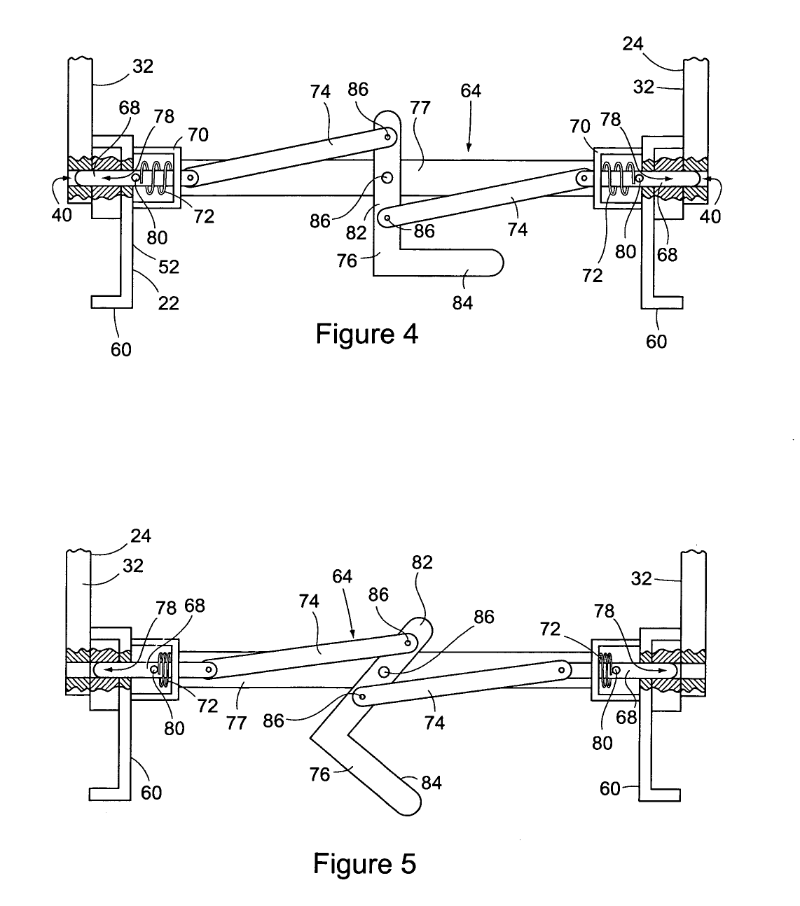

The ladder portion 22 of the ladder assembly 20 preferably comprises first 52 and second 54 sections that are pivotally connected to each other by a pair of hinges 56. Each of the first 52 and second 54 sections preferably comprises a plurality of rungs 58 that span between a pair of spaced apart side members 60. The hinges 56 preferably connect the top ends of the side members 60 of the second section 54 to the bottom ends of the side members 60 of the first section 52. Additionally, the top ends of the side members 60 of the first section 52 are pivotally connected to the mounting member 42 of the attachment portion 24 about a pair of pins 62. The first section 52 of the ladder portion 22 also preferably comprises a locking mechanism 64 (shown in FIG. 4) and a pair of arcuate handrails 66. The handrails 66 are preferably attached to the side members 60 of the first section 52 and preferably extend above the side members.

The locking mechanism 64 is positioned immediately beneath the lowermost rung 58 of the first section 52 of the ladder portion 22. The locking mechanism 64 preferably comprises a pair of locking members 68, a pair of housings 70, a pair of springs 72, a pair of linking members 74, a release member 76, and a brace 77. The locking members 68 are preferably cylindrical pins that are slidably engaged with openings 78 that extend through the side members 60 of the first section 52 of the ladder portion 22. One of the housings 70 is attached to one of the side members 60 of the first section 52 of the ladder portion 22 and the other of the housings is attached to the other of the side members. The springs 72 preferably encircle the locking members 68 and each is preferably compressed between one of the housings 70 and a stop pin 80 that extends through the corresponding locking member in a manner biasing the locking member toward the corresponding side member 60. The release member 76 is preferably L-shaped in a manner forming first 82 and second 84 leg portions. The first leg portion 82 of the release member 76 preferably comprises three equally spaced pivot fittings 86. The center pivot fitting 86 preferably pivotally connects the release member 76 to the center of the brace 77, which spans between the housings 70 and is rigidly connected thereto. The linking members 74 connect each of the other pivot fittings 86 of the release member 76 to the ends of the locking members 68 as shown.

Configured as described above, the second leg portion 84 of the release member 76 acts as a release lever. In particular, when a pulling force is exerted on the second leg portion 84 in a direction generally away from the attachment portion 24 of the ladder assembly 20, a moment or torque is created about the center pivot fitting 86 of the release member 76, which acts to rotate the release member thereabout relative to the remainder of the locking mechanism 64. This rotation of the release member 76 causes the linking members 74 to pull and move the locking members 68 toward each other, against the biasing force of the springs 72, until the locking members are in an unlocking position as shown in FIG. 5. When the release member 76 is released, the biasing action of the springs 72 urge the locking members 68 away from each other and back into their locking position as shown in FIG. 4.

In use, the ladder assembly 20 is preferably secured to the upright tailgate 26 of a vehicle as shown in FIGS. 2 and 3. This is done by positioning the attachment portion 24 of the ladder assembly 20 against the backside 88 of the tailgate 26, with the clamps 30 straddling the top 90 of the tailgate in a manner such that the jaw members 44 of the clamps are engaged with the front 92 of the tailgate. The locking nuts 48 of the clamps 30 are then tightened against the mounting members 42, which causes the tensioning members 46 to pull the jaw members 44 of the clamps toward the main body 28 of the attachment portion 24, thereby clamping the tailgate 26 therebetween. Once clamped, the locking nuts 48 of the clamps 30 are then tightened against each other to prevent them from inadvertently loosening. Additionally, the ladder assembly 20 is preferably further secured to the tailgate 26 by a strap, cable, chain, or the like (not shown) that tensions the bottom portion of the main body 28 of the attachment portion 24 toward an attachment point of the vehicle in a manner forcing the bottom of the main body of the attachment portion against the tailgate. This additional securing of the ladder assembly 20 to the tailgate 26 reduces bending stresses between the jaw members 44 and the tensioning members 46 of the clamps 30 caused by vibrations when the vehicle is moving and also reduces rattling of the lower portion of the attachment portion 24 against the tailgate.

When attached to the tailgate 26 as described, the ladder portion 22 of the ladder assembly 20 can be selectively adjusted between an operable configuration (as shown in FIG. 2) and a stowed configuration (as shown in FIG. 3). In the stowed configuration, the ladder assembly 20 is compact and thereby minimizes any interference with the normal operation of the vehicle. In the operable configuration, the ladder assembly 20 allows people to climb into and out of the vehicle over the upright tailgate 26, with minimal effort.

In the operable configuration, the second section 54 of the ladder portion 22 extends beneath and is inline with the first section 52 of the ladder portion 22. In this position, the hinges 56 that secure the first 52 and second 54 sections of the ladder portion 22 together are fully extended such that the sections bottom-out against each other. Additionally, in this extended position, a releasable latch mechanism (not shown) preferably secures the first 52 and second 54 sections together to prevent the second section of the ladder portion 22 from pivoting back upward relative to the first section of the ladder portion. It should be appreciated that various types of latch mechanisms are well known and that any suitable type of latch mechanism could utilized for this purpose. Furthermore, in the operable configuration, the entire ladder portion 22 of the ladder assembly 20 is pivotally orientated relative to the attachment portion 24 such that the ladder portion is inclined. The ladder portion 22 is preferably fixed in this position by the locking mechanism 64. In particular, the ladder portion 22 is pivotally oriented relative to the attachment portion 24 in a manner such that the second locking holes 40 on the ladder braces 32 of the attachment portion are axially aligned with the locking members 68 of the locking mechanism 64. As such, the locking members 68 extend at least partially into the second locking holes 40 on the ladder braces 32 and thereby pivotally secure the ladder portion 22 in the inclined orientation relative to the attachment portion 24.

As mentioned above, the ladder assembly 20 can be adjusted from the operable configuration to the stowed configuration. To do this, the latch mechanism preventing pivotal movement between the first 52 and second 54 sections of the ladder portion 22 is released and, thereafter, the second section is pivoted upward relative to the first section until it bears thereagainst. In this collapsed position of the ladder portion 22, another releasable latch mechanism (not shown) preferably secures the first 52 and second 54 sections together to prevent the second section of the ladder portion 22 from pivoting back downward to the extended configuration. This latch mechanism is preferably positioned near the upper most portion of the first section 52 of the ladder portion 22 so that it can be accessed by a person positioned in or on the vehicle by reaching over the tailgate 26. Again, it should be appreciated that various types of latch mechanisms are well known and that any suitable type of latch mechanism could be utilized for this purpose.

Additionally, during the adjustment between the operable and stowed configurations, the second leg portion 84 of the release member 76 of the locking mechanism 64 is grasped and pulled in a direction away from the backside 88 of the tailgate 26, thereby releasing the ladder portion 22 in manner allowing it to pivot relative to the attachment portion 24. Once released, the entire ladder portion 22 is pivoted downward relative to the attachment portion 24 until the first locking holes 38 on the ladder braces 32 of the attachment portion are axially aligned with the locking members 68 of the locking mechanism 64. The release member 76 of the locking mechanism 64 is then released, thereby allowing the locking members 68 to move at least partially into the first locking holes 40 on the ladder braces 32 to pivotally secure the ladder portion 22 in orientation relative to the attachment portion 24.

The above mentioned steps can be reversed to adjust the ladder assembly 20 back into its operable configuration. However, during such procedure, it is preferable to adjust the orientation of the first 52 and second sections 54 of the ladder portion 22 relative to each other prior to adjusting the orientation of the ladder portion relative to the attachment portion 24. Additionally, it should be appreciated that the locking mechanism 64 is preferably specifically configured and adapted so that the force and action required to unlock the ladder portion 22 relative to the attachment portion 24 acts in a direction that facilitates the necessary lifting of the ladder portion 22 required to bring it into the inclined position. This allows for single-handed adjustment of the ladder assembly 20 between its various configurations. Still further, it should be appreciated that the adjustable nature of the clamps 30 of the attachment portion 24 of the ladder assembly 20 allow the ladder assembly to be firmly attached to tailgates of differing thickness. Thus, the same ladder assembly can be firmly attached to a variety of types of vehicles.

While the present invention has been described in reference to a specific embodiment, in light of the foregoing, it should be understood that all matter contained in the above description or shown in the accompanying drawings is intended to be interpreted as illustrative and not in a limiting sense and that various modifications and variations of the invention may be constructed without departing from the scope of the invention defined by the following claims. Most notably, it should be appreciated that all of the elements or method steps described in reference to the preferred embodiment need be present or performed. Thus, other possible variations and modifications should be appreciated.

Furthermore, it should be understood that when introducing elements of the present invention in the claims or in the above description of the preferred embodiment of the invention, the terms “comprising,” “including,” and “having” are intended to be open-ended and mean that there may be additional elements other than the listed elements. Similarly, the term “portion” should be construed as meaning some or all of the item or element that it qualifies.

1. A ladder assembly comprising:
a ladder portion and an attachment portion, the ladder portion having a plurality of rungs and being pivotally connected to the attachment portion, the attachment portion having a clamping device that is configured and adapted to releasably secure the attachment portion to an upright tailgate of a vehicle, the ladder portion being selectively lockable in at least a first pivotal orientation relative to the attachment portion.

2. A ladder assembly in accordance with claim 1 wherein the ladder portion comprises first and second sections, each of the first and second sections of the ladder portion comprising a plurality of the rungs, the first section of the ladder portion being movably connected to the second section of the ladder portion in a manner such that the ladder portion is adjustable between a collapsed configuration and an extended configuration.

3. A ladder assembly in accordance with claim 2 wherein the first section of the ladder portion is pivotally connected to the second section of the ladder portion such that the ladder portion is adjustable between the collapsed configuration and the extended configuration by pivotally moving the first section relative to the second section.

4. A ladder assembly in accordance with claim 1 wherein the ladder portion is selectively lockable in a second pivotal orientation relative to the attachment portion.

5. A ladder assembly in accordance with claim 4 further comprising a locking mechanism, the locking mechanism being fixed to the ladder portion in a manner such that the locking mechanism pivots with the ladder portion relative to the attachment portion, the locking mechanism comprising a movable locking member and a movable release member, the locking member being movable between a locking position and an unlocking position and being biased from the unlocking position toward the locking position, the locking member being engagable with the attachment portion when the locking member is in the locking position in a manner to selectively lock the ladder portion in the first and second pivotal orientations relative to the attachment portion, the release member being operatively connected to the locking member in a manner such that the locking member is movable from the locking position to the unlocking position in response to a force applied to the release member.

6. A ladder assembly in accordance with claim 5 wherein the pivotal connection between the ladder portion and the attachment portion defines an axis, and wherein the release member is configured such that the force applied to the release member creates a torque on the ladder portion that acts about the axis.

7. A vehicle comprising;
an upright tailgate; and
a ladder assembly in accordance with claim 1, the attachment portion of the ladder assembly being secured to the upright tailgate via the clamping device.

8. A vehicle in accordance with claim 7 wherein the upright tailgate comprises a top surface and opposite front and back sides, and wherein the clamping device comprises cooperating threaded members and first and second clamping members, the cooperating threaded members being threadably engaged with each other and being connected to the first and second clamping members in a manner such that rotational movement of the cooperating threaded members relative to each other acts to force the first and second clamping members toward each other, one of the first and second clamping members being engaged with one of the front and back sides of the upright tailgate, the other of the first and second clamping members being engaged with the other of the front and back sides of the upright tailgate, the first and second clamping members being forced toward each other via the cooperating threaded members.

9. A method comprising:
providing a vehicle, the vehicle comprising an upright tailgate;
providing a ladder assembly, the ladder assembly comprising a ladder portion and an attachment portion, the ladder portion having first and second sections, each of the first and second sections of the ladder portion comprising a plurality of rungs, the first section of the ladder portion being movably connected to the second section of the ladder portion in a manner such that the ladder portion is adjustable between a collapsed configuration and an extended configuration, the first section of the ladder portion also being pivotally connected to the attachment portion and selectively lockable in at least a first pivotal orientation relative to the attachment portion;
attaching the attachment portion of the ladder assembly to the tailgate of the vehicle;
pivoting the ladder portion relative to the attachment portion in a manner moving the first section of the ladder portion to the first pivotal orientation relative to the attachment portion;
locking the first section of the ladder portion in the first pivotal orientation relative to the attachment portion; and
moving the second section of the ladder portion relative to the first section of the ladder portion in a manner adjusting the ladder portion between the collapsed configuration and the extended configuration.

10. A method in accordance with claim 9 wherein the step of providing the vehicle occurs in a manner such that the upright tailgate of the vehicle comprises a top surface and opposite front and back sides, and wherein the step of providing the ladder assembly occurs in a manner such that the attachment portion of the ladder assembly comprises an adjustable clamp, the step of attaching the attachment portion of the ladder assembly to the tailgate of the vehicle comprising adjusting the clamp of the attachment portion in a manner such that the clamp applies a clamping force against the front and back sides of the tailgate and occurring in a manner such that the attachment portion straddles the top surface of the tailgate.

11. A method in accordance with claim 10 wherein the step of providing the ladder assembly occurs in a manner such that the clamping device comprises cooperating threaded members and first and second clamping members, the cooperating threaded members being threadably engaged with each other, the step of attaching the attachment portion of the ladder assembly to the tailgate of the vehicle comprising rotating the cooperating threaded members relative to each other in a manner generating the clamping force.

12. A method in accordance with claim 9 wherein the step of moving the second section of the ladder portion relative to the first section of the ladder portion comprises pivotally moving the first and second sections relative to each other.

13. A method in accordance with claim 9 wherein the step of providing the ladder assembly occurs in a manner such that the first section of the ladder portion is selectively lockable in a second pivotal orientation relative to the attachment portion, and wherein the method further comprises steps of:
unlocking the first section of the ladder portion from the first pivotal orientation;
moving the first section of the ladder portion from the first pivotal orientation to the second pivotal orientation; and
locking the first section of the ladder portion in the second pivotal orientation.

14. A method in accordance with claim 13 wherein the step of providing the ladder assembly occurs in a manner such that the ladder portion comprises a movable release member and such that the first section of the ladder portion is biased from the second pivotal orientation to the first pivotal orientation by gravity, the step of unlocking the first section of the ladder portion from the first pivotal orientation comprising exerting a force on the release member in a manner causing the release member to move relative to the first section so as to thereby unlock the first section of the ladder portion from the first pivotal orientation, the force acting in a direction to counteract the gravitational biasing that acts on the first section of the ladder portion.

15. A method comprising:
providing a vehicle, the vehicle comprising an upright tailgate, the upright tailgate having a top surface and opposite front and back sides;
providing a ladder assembly, the ladder assembly comprising a ladder portion and an attachment portion, the ladder portion comprising a plurality of rungs, the attachment portion comprising an adjustable clamp, the ladder portion being connected to the attachment portion;
attaching the attachment portion of the ladder assembly to the tailgate of the vehicle in a manner such that the attachment portion straddles the top surface of the tailgate;
adjusting the clamp of the attachment portion in a manner such that the clamp applies a clamping force against the front and back sides of the tailgate.

16. A method in accordance with claim 15 wherein the step of providing the ladder assembly occurs in a manner such that the ladder portion comprises first and second sections, each of the first and second sections of the ladder portion comprising a plurality of the rungs, the first section of the ladder portion being movably connected to the second section of the ladder portion in a manner such that the ladder portion is adjustable between a collapsed configuration and an extended configuration, the method further comprising a step of moving the second section of the ladder portion relative to the first section of the ladder portion in a manner adjusting the ladder portion between the collapsed configuration and the extended configuration.

17. A method in accordance with claim 16 wherein the step of moving the second section of the ladder portion relative to the first section of the ladder portion comprises pivotally moving the first and second sections relative to each other.

18. A method in accordance with claim 15 wherein the step of providing the ladder assembly occurs in a manner such that the ladder portion is pivotally connected to the attachment portion and selectively lockable in at least a first pivotal orientation relative to the attachment portion, and wherein the method further comprises a step of locking the ladder portion in the first pivotal orientation relative to the attachment portion.

19. A method in accordance with claim 18 wherein the step of providing the ladder assembly occurs in a manner such that the ladder portion is selectively lockable in a second pivotal orientation relative to the attachment portion, and wherein the method further comprises steps of:
unlocking the ladder portion from the first pivotal orientation;
moving the ladder portion from the first pivotal orientation to the second pivotal orientation; and
locking the ladder portion in the second pivotal orientation.

20. A method in accordance with claim 19 wherein the step of providing the ladder assembly occurs in a manner such that the ladder portion comprises a movable release member and such that the ladder portion is biased from the second pivotal orientation to the first pivotal orientation by gravity, the step of unlocking the ladder portion from the first pivotal orientation comprising exerting a force on the release member that causes the release member to move relative to the ladder portion in a manner thereby unlocking the ladder portion from the first pivotal orientation, the force acting in a direction to counteract the gravitational biasing that acts on the ladder portion.

21. A method in accordance with claim 15 wherein the step of providing the ladder assembly occurs in a manner such that the clamping device comprises cooperating threaded members and first and second clamping members, the cooperating threaded members being threadably engaged with each other, the step of attaching the attachment portion of the ladder assembly to the tailgate of the vehicle comprising rotating the cooperating threaded members relative to each other in a manner generating the clamping force.

22. A ladder assembly comprising:
a ladder portion and an attachment portion, the ladder portion having first and second sections, each of the first and second sections of the ladder portion comprising a plurality of rungs, the first section of the ladder portion being movably connected to the second section of the ladder portion in a manner such that the ladder portion is adjustable between a collapsed configuration and an extended configuration, the first section of the ladder portion also being pivotally connected to the attachment portion and selectively lockable in at least a first pivotal orientation relative to the attachment portion, the attachment portion of the ladder assembly being configured and adapted to attach to an upright tailgate of the vehicle.

23. A vehicle comprising;
an upright tailgate; and
a ladder assembly in accordance with claim 22, the attachment portion of the ladder assembly being secured to the upright tailgate.

24. A vehicle in accordance with claim 23 wherein the attachment portion of the ladder assembly comprises an adjustable clamping device, the attachment portion of the ladder assembly being secured to the upright tailgate via the clamping device.

25. A ladder assembly in accordance with claim 22 wherein the first section of the ladder portion is pivotally connected to the second section of the ladder portion such that the ladder portion is adjustable between the collapsed configuration and the extended configuration by pivotally moving the first section relative to the second section.

26. A ladder assembly in accordance with claim 22 wherein the first section of the ladder portion is selectively lockable in a second pivotal orientation relative to the attachment portion.

27. A ladder assembly in accordance with claim 26 further comprising a locking mechanism, the locking mechanism being fixed to the first section of the ladder portion in a manner such that the locking mechanism pivots with the first section of the ladder portion relative to the attachment portion, the locking mechanism comprising a movable locking member and a movable release member, the locking member being movable between a locking position and an unlocking position and being biased from the unlocking position toward the locking position, the locking member being engagable with the attachment portion when the locking member is in the locking position in a manner to selectively lock the first section of the ladder portion in the first and second pivotal orientations relative to the attachment portion, the release member being operatively connected to the locking member in a manner such that the locking member is movable from the locking position to the unlocking position in response to a force applied to the release member.

28. A ladder assembly in accordance with claim 27 wherein the pivotal connection between the ladder portion and the attachment portion defines an axis, and wherein the release member is configured such that the force applied to the release member creates a torque on the ladder portion that acts about the axis.
